(19) United States
(12) Patent Application Publication
(10) Pub. No.: US 2002/0178295 A1
(43) Pub. Date: Nov. 28, 2002

(54) Distributed gateways for remote management of USB-compatible devices

(76) Inventors: Joseph Buczek, San Jose, CA (US); Neil J. Cormia, San Jose, CA (US)

Correspondence Address: Terry McHugh, Law Offices of Terry McHugh, 101 First Street, PMB 560, Los Altos, CA, 94022, US

(21) Appl. No.: 10/097,979

(22) Filed: Mar. 13, 2002

Related U.S. Application Data
(60) Provisional application No. 60/293,337, filed on May 23, 2001.

(51) Int. Cl. G06F 15/16

(52) U.S. Cl. 709/250; 709/220

(57) ABSTRACT

A remotely managed Universal Serial Bus (USB) gateway supports any of a variety of different types of USB peripheral devices, but is remotely operated and managed by a centralized service provider. The remotely managed USB gateway is dedicated to functioning as an intermediary between the remote service provider and the supported peripheral devices or devices. The service provider transfers application software, settings and subscription content (in some applications) to individual gateways and their supported peripheral devices.

### CROSS REFERENCE

This application claims the benefit of U.S. Provisional Application No. 60/293,337, filed May 23, 2001.

### TECHNICAL FIELD

The invention relates generally to managing and operating distributed devices and more particularly to managing devices via the global communications network referred to as the Internet.

### BACKGROUND ART

Both business and non-business opportunities exist in which it is beneficial to allow electronic devices to be managed from one or more remote locations. With some types of electronic equipment (e.g., residential telephone answering devices), remote management and access can be relatively simple. Other devices require a relatively high level of sophistication, particularly if control of a local device is to be extended both to a remote centralized facility and one or more remote smaller scale locations at which device administrators or end-users are located. As one example, a camera may be used to capture images for security or entertainment reasons, with the images being immediately or periodically transmitted to a centralized facility for processing or redistribution to various locations.

“Web cameras” may be used to periodically upload images to a web server for public accessibility by entering a specific Uniform Resource Locator (URL) into the “Location” line of a web browser. However, the ability to provide remote control over the process adds a significant degree of complexity, so the periodic updates are typically controlled locally by the programming of a general purpose personal computer connected to the web camera. In addition to the personal computer and the web camera, the conventional approach requires an Internet Service Provider (ISP) having a local Point Of Presence (POP). A modem or a broader bandwidth device connects the controlling personal computer to the ISP to allow images to be uploaded.

A business application of the automatic uploading is described in U.S. Pat. No. 6,166,729 to Acosta et al. The remote viewing system described in this patent may be used for providing security. Camera devices are connected to wireless transmitters to transfer images to a central office video management system which is connected to a World Wide Web (WWW) server. The WWW server is connected to the Internet, but privacy restrictions are imposed to allow computers to access only certain digital images.

A concern with prior art systems and methods is that they are often complex, so that a high level of computer sophistication is needed to fully utilize the remote control capability of such systems. Another concern is that many of the systems require an intermediate ISP. What is needed is a system and method that provide a greater versatility in meeting the requirements of end-users of a service, without requiring a high level of computer sophistication.

### SUMMARY OF THE INVENTION

A remotely managed Universal Serial Bus (USB) gateway is used to support any of a variety of USB peripheral devices, allowing a currently supported USB peripheral device to be remotely operated and managed through computer software loaded into the gateway. As compared to a general purpose personal computer, the remotely managed USB gateway is dedicated to functioning as an intermediary between the supported peripheral device and a service provider having network connectivity to the gateway. The “management” of the USB peripheral device may be limited to providing instructions and commands relating to the device operations, such as when the device is a remote camera for uploading images, or may be related to delivering content to the peripheral device, such as when the delivered content is subscriber based. Subscriber-based content may include, but is not limited to, audio files (e.g., MP3 files), video files, articles for a personal digital assistant (PDA), or programs and upgrades for a PDA.

Typically, the remotely managed USB gateway does not include any user controls. That is, there is no keyboard, computer mouse or other user input equipment connected directly to the USB gateway. Rather, all control of the USB gateway is accomplished through remote manipulation by the service provider. The USB gateway may be programmed to periodically contact the service provider via a dial-up network connection over the Internet. Alternatively, the USB gateway provides connectivity to the Internet via a built-in Ethernet port. Upon contacting the service provider, the USB gateway presents authenticating data which allows the service provider to determine the appropriate management parameters. The authenticating data allows the service provider to uniquely identify the USB gateway for operational purposes. The service provider may be used to present the USB peripheral device with any or all of control information, settings, files, executable images, and other data that may be used to accomplish user-desired behavior of the service provider/device combination.

Since a gateway is used to support the USB peripheral device, it is possible to use a dial-up modem to directly contact the service provider. That is, an Internet connection is not necessary for all communications between the service provider and one of the USB peripheral devices. In order to allow communications to be initiated by the service provider, the modem may be equipped with caller identification capability. This capability enables the modem to observe caller identifications of incoming calls received along the line to which the modem is connected. Typically, the modem does not “answer” incoming calls, so that a connection between the USB gateway and the service provider is not completed. In fact, the duration of the incoming call may be kept sufficiently short to cause the call to be operationally transparent to other devices on the same line, e.g., so short that a residential telephone is unlikely to ring. This may be used as a cost-saving feature of the invention. Instead of answering the incoming call, the recognition of an incoming call having a specific calling telephone number may trigger a particular action, such as causing the USB gateway or the peripheral device to immediately contact the service provider (e.g., using a 1-800 number) or causing the peripheral device to reset to “factory preset” conditions.

An advantage of the invention is that the USB gateway can be easily reconfigured to change its basic purpose. For example, the gateway may be initially programmed to support a web camera, but may then be remotely changed for use in supporting an MP3 subscription device.

The service provider will typically include a standard web server and will support web browser technology. The service provider of a particular system functions as a central facility in managing distributed devices, since each of the devices is connected to a remotely managed USB gateway. The communication protocol between the service provider and the various gateways may be the Hyper Text Transfer Protocol (HTTP). Optionally, access to management and viewing interfaces for individual devices is through a standard web browser. For applications in which the management is to be extended to other locations, web access is used. For example, in the management of a web camera, the owner of a particular web camera may access management of that camera (e.g., determining upload times) by entering a password that activates the presentation of the management and viewing interfaces relevant to that camera.

### BRIEF DESCRIPTION OF THE DRAWINGS

FIG. 1 is a block diagram of a system for remotely managing distributed devices in accordance with the invention.

FIG. 2 is a block diagram that includes the hardware components of one of the USB gateways of FIG. 1.

FIG. 3 is a block diagram that includes software components of one of the USB gateways of FIG. 1.

FIG. 4 is a process flow of steps for remotely managing one of the USB peripheral devices of FIG. 1.

### DETAILED DESCRIPTION

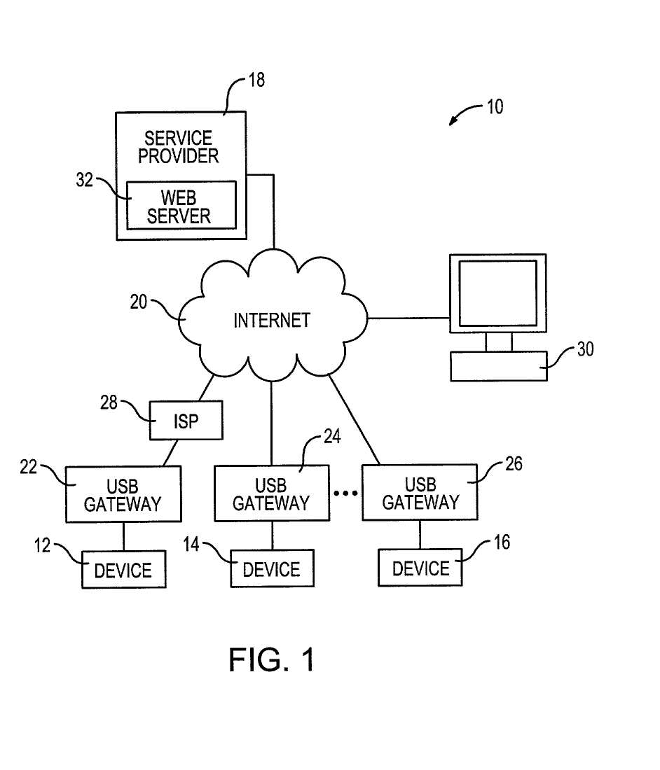

With reference to FIG. 1, a system 10 for managing distributed devices 12, 14 and 16 is shown as including a service provider 18 connected to the global communications network referred to as the Internet 20. In one application of the invention, the service provider is a facility for enabling web cameras, so that the devices are digital cameras that capture image information. The captured image information may be publicly accessible via the Internet or may have restricted access, such as in a security application in which different sites are monitored. The service provider 18 serves as a repository for images captured by the various camera devices. However, there are other applications of the invention, including providing PDA subscription delivery, providing audio file subscription delivery for an MP3 player, or providing video subscription delivery.

Each of the devices 12,14 and 16 is connected to a USB gateway 22, 24 and 26, respectively. The gateways are dedicated to supporting the devices. That is, the gateways are not general purpose personal computers. In fact, the USB gateways may be completely enclosed, other than a USB connection to the associated device and a network connection. The network interface equipment for the network connection may be a dial-up modem or may be a broader bandwidth device, such as an Ethernet adapter. The network interface provides Transmission Control Protocol//Internet Protocol (TCP/IP) connection to the service provider 18. As shown in FIG. 1, the USB gateway 22 uses an Internet Service Provider 28 (ISP) for connectivity to the Internet 20, but an ISP is not critical to connectivity, since the gateway is capable of connecting directly to the service provider.

Optionally, the management system 10 permits on-site or off-site control through the use of a conventional Internet connection. A general purpose personal computer 30 is shown as being linked to the Internet 20 to enable off-site control using the capabilities of the service provider 18. While the service provider 18 may also include a personal computer that is used for administration purposes, the personal computer 30 is remote from the service provider. The web interface to the service provider is the only operational component of the service that is visible to a user at the personal computer. The web interface may be used to enter preferences, billing information or similar user-specific data. For example, in a web camera operation, the user may enter preferences such as the frequency of image uploads, the image quality, and any size parameters. Images that are uploaded are stored within a conventional web server 32 of the service provider 18.

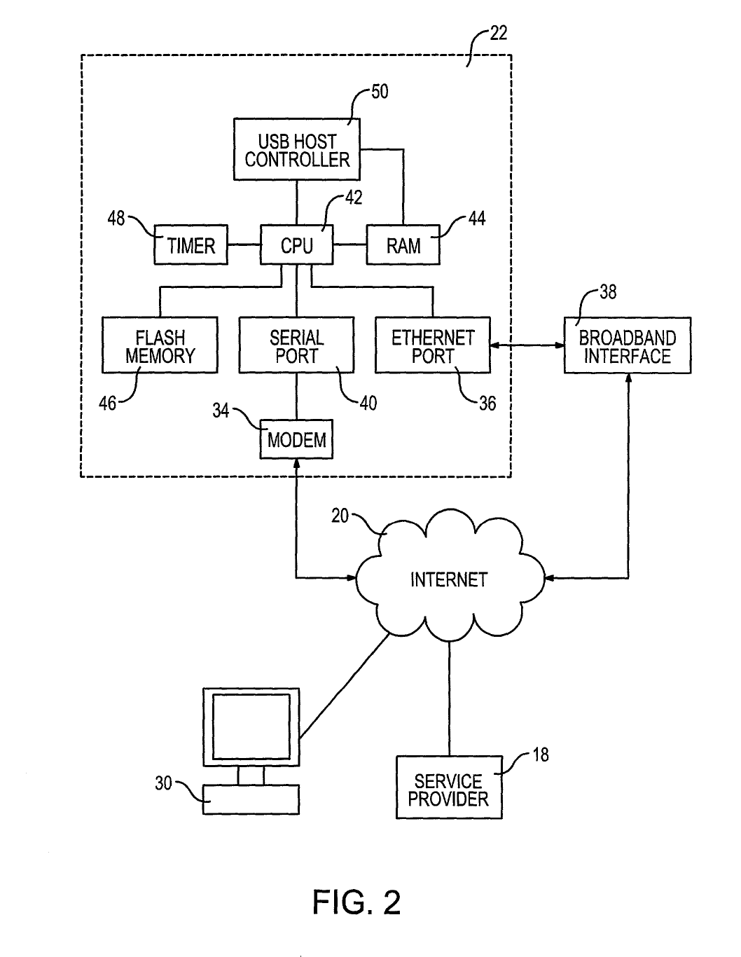

FIG. 2 shows the hardware components of one embodiment of a USB gateway 22 in accordance with the invention. Either a modem 34 or an Ethernet port 36 may be used to provide connectivity to the Internet 20. The Ethernet port is shown as being linked to a broadband interface 38 which connects to the Internet. In addition to modems and Ethernet links, other network interfaces may be substituted or added. The network interfaces function in a manner consistent with known technology.

The processing within the USB gateway 22 is managed by a central processing unit (CPU) 42. Volatile memory is provided by a random access memory (RAM) component 44, while non-volatile memory is implemented as a flash memory component 46. The flash memory component may store authentication data, settings, and other information that is necessary over an extended period of time.

For some applications, a timer 48 is important. As one example, in a security application in which image information is to be periodically updated, the timer is used by the CPU 42 as a scheduler to timely initiate operations.

A USB host controller 50 enables one or more USB-compatible peripheral devices to be connected to the gateway 22. The controller may be any one of a number of different commercially available USB host controllers. As can be seen in FIG. 2, the gateway 22 does not include a local monitor or the user input device such as a keyboard or computer mouse. While these items may be added, they are not necessary, since the service provider 18 determines remote management of the gateway and the connected USB peripheral device or devices.

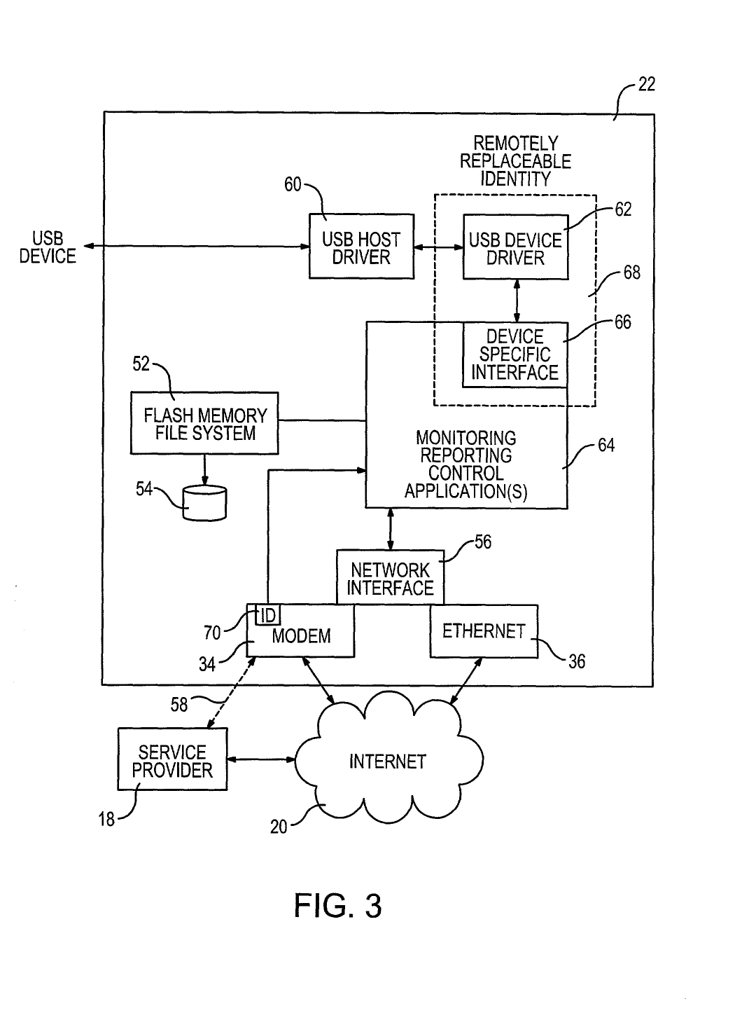

FIG. 3 illustrates the invention from a software perspective. The USB gateway 22 includes a flash memory file system 52 connected to non-volatile memory 54. The stored information includes a protocol converter to allow the information received via the Internet 20 to be converted from a TCP/IP format to a protocol that is compatible with operation of the USB gateway 22 and the supported USB peripheral device.

As previously noted, the USB device 22 is able to communicate through the Internet 20 by operation of a network interface 56, which may include a modem 34 and an Ethernet port 36. The modem may be an internal analog modem, that links to the Internet or directly to the service provider 18, as represented by the dashed line 58. For example, the direct connection to the service provider may be periodically established by programming the gateway to dial a toll-free number on a periodic basis. A wireless version of the gateway may be provided by using a connector, such as a PCMCIA connector, to enable the wireless communication.

The gateway 22 includes a USB host driver 60 that is not specific to any type of peripheral device. On the other hand, a USB device driver 62 is driver software that relates directly to the USB device currently connected to the gateway 22.

Processing software is represented by component 64. An applications portion of component 64 represents computer programs for performing such tasks as monitoring, reporting and controlling operations of the supported peripheral device. Since the programs are stored in memory, the USB gateway 22 can be reprogrammed to change the purpose of the gateway, if the supported USB peripheral device is changed. For example, a gateway that is programmed to support an MP3 player subscription may be reprogrammed to function as a camera gateway for a USB-compatible security camera.

The processing software component 64 includes a device-specific interface 66 that cooperates with the USB device driver 62 for communications between the gateway 22 and the supported peripheral device. The device-specific interface includes identification information for the supported device. A box 68 around the USB device driver 62 and the device-specific interface 66 represents identity software that is replaceable by operation of the service provider 18 or by operation of another service provider when the purpose of the gateway 22 is changed.

Optionally, the USB gateway 22 may be remotely activated using a caller-identification capability 70 of the modem 34. A gateway equipped with a caller-ID capable modem is able to monitor incoming calls along a telephone line to which the modem is attached. On the basis of specifics determined by the service provider 18, the gateway can respond to recognition of an incoming call to perform a particular action. As examples, the gateway may automatically reset to factory preset conditions or may immediately initiate a call to the service provider using a toll-free number. Typically, the gateway does not answer the incoming call, since there is likely to be a more cost-efficient mechanism for achieving the desired interaction. Thus, the double arrows on the dashed line 58 in FIG. 3 may represent (1) the initial unanswered incoming call from the service provider 18 to the USB gateway and (2) the responsive outgoing call from the USB gateway to the service provider.

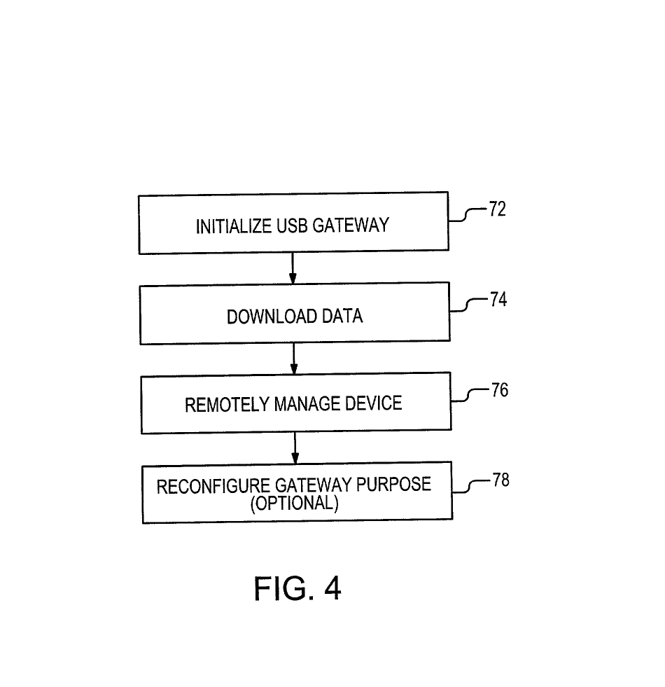

The operations of a particular USB gateway 22 will be described with reference to FIG. 4. At step 72, a USB gateway 22 is initialized by a particular service provider 18. Since the gateway typically does not include any user controls (e.g., a keyboard), the control of the gateway is accomplished through remote manipulation by the service provider. Upon connecting to the service provider, the gateway presents authenticating data which allows the service provider to determine appropriate information to be sent to the gateway. The authenticating data allows the service provider to uniquely identify the USB-compatible peripheral device 12, 14 and 16 that is supported by the gateway. Thus, the device 12 provides the information to the gateway for transmission to the service provider.

Interactivity among the service provider 18, the USB gateway 22 and the peripheral device 12 supported by the gateway is determined by the identification of the device. The service provider presents the gateway and the device with control information, settings, files, executable images, and any other data that is needed to accomplish the desired operations. The transfer of such data is represented by step 74 in FIG. 4.

In step 76, the continued operation of the USB peripheral device 12 is remotely managed by the service provider 18. The remote management may include normal maintenance, “bug” fixes, and periodic upgrades. For subscription services, such as PDA management or MP3 player management, the step of remotely managing the device includes meeting the subscription requirements in a timely manner. The service provider establishes a framework for conducting business based around the deployment of the supported peripheral devices 12, 14 and 16. Different business entities may cooperate through the service provider, such as a security-oriented remote camera service available to more than one security business or an MP3 subscription service utilized by more than one music publishing company.

The device-specific interface 66 of FIG. 3 will be selected by the remote service provider 18 on the basis of the target application of the supported device 12. The device-specific interface 66 that is necessary for operation of a remote camera gateway is significantly different than that needed to operate an MP3 subscription device.

The remote management step 76 may be primarily based upon acquiring content from the supported device 12, 14 and 16. For example, in the remote camera gateway application, the service provider functions as a means for managing and displaying captured images. Optionally, the service provider enables selections from among different ways of viewing and collecting images or sequences of images. The service provider may initiate the connections to the gateways 22, 24 and 26 to trigger the uploads of image files or other content. On the other hand, the gateways may be programmed to periodically initiate connectivity to the service provider.

Rather than acquiring content from the individual USB gateways 22, 24 and 26, the service provider 18 may be primarily responsible for transferring content to the gateways. This would be the case for subscription applications. Thus, if the gateway is configured to be a PDA subscription gateway, the end user might be an owner of a PDA who has subscribed to obtaining certain types of articles or obtaining articles from certain periodicals. The service provider may establish an ability to select data on a programmable basis.

Step 78 of FIG. 4 represents the optional step of reconfiguring the gateway to change its purpose. That is, the gateway may be reprogrammed to provide support for a peripheral device of a type different than the one for which the gateway was originally initialized at step 72. This would occur if the originally attached peripheral device were to be replaced with a substitute device of a different type.

What is claimed is:

1. A system for managing distributed devices comprising:
a service provider having at least one web server that is configured to enable first communications with remote computers running web browser software, said first communications including operation parameters for managing support of said distributed devices, said service provider being configured to enable second communications for supporting said distributed devices, said second communications being partially responsive to said first communications;
a plurality of gateways dedicated to supporting remote management of said distributed devices, each said gateway having a network interface configured for selective connection of said gateway to said service provider for said second communications, each said gateway having a Universal Serial Bus (USB) interface for connection to one of said distributed devices and having a stored service application that is responsive to said second communications and that is specific to managing a particular said distributed device to which said gateway is connected; and
said distributed devices.

2. The system of claim 1 further comprising a plurality of said service providers, each said service provider being related to a different service, said gateways being reconfigurable to support said different services.

3. The system of claim 2 wherein said different services include at least two of video exchange support, audio subscription to said distributed devices, and personal digital assistant subscription service.

4. The system of claim 1 wherein said network interfaces of said gateways are dial-up modems for accessing said service provider via the global communications network referred to as the Internet.

5. The system of claim 1 wherein said service provider is configured to generate management interfaces at said remote computers as a consequence of said first communications, said management interfaces being related to operations of said distributed devices.

6. The system of claim 1 wherein each said gateway is an enclosed device that is specific with respect to enabling remote management of a supported device connected to said USB interface, while be general with respect to enabling alternative supported devices to be connected to said USB interface for remote management.

7. The system of claim 6 wherein each said gateway includes application software that is specific to said supported device currently connected to said USB interface.

8. A gateway dedicated to enabling remote operations of a supported device comprising:
a housing;
a Universal Serail Bus (USB) interface configured to alternatively couple to any of a plurality of devices, said USB interface being connected to said housing;
a driver located within said housing, said driver being configured to control a device currently coupled to said USB interface, said device being said supported device;
a protocol converter located within said housing and configured to enable signal exchanges between said supported device and the global communications network referred to as the Internet; and
a network interface connected to said housing to enable connectivity to said Internet.

9. The gateway of claim 8 wherein said housing defines an enclosure having an absence of connections to user input devices, such that programming of gateway said gateway is limited to input via said USB interface and said network interface.

10. The gateway of claim 8 wherein said network interface and said protocol converter are cooperative to enable connectivity with a remote provider of device service specific to said supported device.

11. The gateway of claim 10 wherein said network interface is a dial-up modem and said connectivity is independent of access via an Internet Service Provider (ISP).

12. The gateway of claim 10 further comprising a processor and memory operatively associated with said protocol converter and said driver to enable remote operation and management of said supported device via said device service, said memory having stored application software that is specific to said supported device.

13. The gateway of claim 12 wherein said processor is responsive to inputs channeled through said device service from a remote computer executing a web browser.

14. The gateway of claim 8 further comprising a caller identification module configured to be responsive to preselected telephone numbers.

15. A method of supporting distributed devices comprising the steps of:
enabling each said device to be supported via a Universal Serial Bus (USB) connection;
connecting each said device to a USB port of a gateway that is dedicated to supporting one of said devices, including providing application software to said gateways to which said devices are connected, each said gateway having a network interface for connection via the Internet;
selectively accessing said gateways using the Internet and a service provider;
transmitting operation information from said service provider to said gateways for operating said devices; and
processing said operation information at said gateways, including managing communications between individual said gateways and said devices on the basis of said operation information received by said individual gateways from said service provider.

16. The method of claim 15 further comprising the step of reprogramming individual said gateways when said USB ports of said individual gateways are disconnected from one type of supported device and connected to a second type of supported device.
